(19) United States
(12) Patent Application Publication
(10) Pub. No.: US 2021/0187571 A1
(43) Pub. Date: Jun. 24, 2021

(54) SYSTEM FOR SYNTHETIC TURF FIELDS FOR LANDFILLS

(71) Applicant: The Hanson Group LLC, Peachtree Corners, GA (US)

(72) Inventor: Wallace Lee Hanson, JR., Peachtree Corners, GA (US)

(21) Appl. No.: 17/126,955

(22) Filed: Dec. 18, 2020

Related U.S. Application Data
(60) Provisional application No. 62/951,619, filed on Dec. 20, 2019.

(51) Int. Cl. B09B 1/00; E01C 13/08

(52) U.S. Cl. CPC B09B 1/004; E01C 13/08

(57) ABSTRACT

The disclosure concerns a device configured for trapping methane gas, the device comprising a synthetic turf and a polyurea or polyurethane coating disposed at a surface of the synthetic turf. The device reduces passage of methane gas therethrough.

### CROSS-REFERENCE TO RELATED APPLICATIONS

This application claims priority under 35 U.S.C. § 119 (e) to U.S. provisional application Ser. No. 62/951,619, filed on Dec. 20, 2019 entitled “System for Synthetic Turf Fields for Landfills,” which is herein incorporated by reference in its entirety.

### TECHNICAL FIELD

The disclosure relates to materials that can be used to make synthetic turf fields, specifically synthetic turf fields for use in landfills.

### BACKGROUND

Synthetic or artificial turfs are used in homes, commercial and industrial properties, and in recreational areas such as athletic arenas for sports that were traditionally played on natural grass fields. As such artificial turf ages or wears over time, there arises a need for replacement as well as disposal of the aged turf. Landfill disposal of these turfs may be expensive. And, given the varied number of components that make up synthetic turf, recycling may not be a feasible alternative. These and other concerns are addressed in the present disclosure.

### SUMMARY

Aspects of the present disclosure relate to a coated synthetic turf comprising a synthetic turf comprising a plurality of fibers and a backing and a film having a thickness of from about 30 mil to 80 mil disposed at a surface of the synthetic turf. The film comprises a polyurea, a polyurethane, or a combination thereof, and the coated synthetic turf is configured to reduce passage of methane gas.

Other aspects of the present disclosure relate to a method of forming a synthetic coating having a polyurea or polyurethane coating thereupon.

### DETAILED DESCRIPTION

An artificial turf, or synthetic turf, may be described as a grass-like, man-made surface fabricated from synthetic materials. These turfs have a number of uses among residential, commercial, and industrial applications. Synthetic turf is commonly used in recreational areas and common areas for multiunit dwellings and also arenas for sports that were originally played on natural grass. Conventional synthetic turf may include polyethylene fiber or “grass” of a few to several centimeters. This grass may be lubricated and incorporated into a woven backing fabric the rear of which may be coated with a backing medium (such as a polymer) to situate the tufts. Optionally, the underside of the pile fabric may be provided with a resinous coating which functions to secure the tufts in place, to increase the dimensional stability of the backing and to increase the moisture resistance of the backing. The components used for artificial turf include a number of materials such as fibers, filaments and tapes, and if applicable infill materials.

Currently there are over 15,000-20,000 synthetic turf fields in use in the USA. New and replacement fields may number 1,500-2,000 per year. Each year, there are 500-800 synthetic turf fields being taken up and replaced, with the life cycle of a given field being approximately 10 years. There has been an issue of what to do with the synthetic turf that has been removed. There are typically significant costs associated with disposing the turf in a landfill. Recycling measures have been considered, but a given synthetic turf may include multiple materials that are not readily or easily separable. As an alternative, a synthetic turf may be applied over a completed landfill to cloak the area with artificial greenery. Decomposing waste in landfills produce gas which is a mixture of methane and carbon dioxide, making landfills one of the largest sources of methane emissions in the United States, with municipal solid waste landfills representing 95 percent of this fraction. A coated synthetic turf as provided herein may thus give a landfill a desirable green grass appearance while containing at least a portion of these high methane gas levels. As an example, pieces of a coated synthetic turf, prepared from removed or aged synthetic turf, may be joined and combined to be placed on top of a landfill.

Aspects of the present disclosure provide a synthetic turf configured to cover landfills to provide aesthetic coverage and to contain methane gas release from the waste of the landfill. The present disclosure provides a synthetic turf having a polyurea and/or polyurethane coating applied thereon to trap methane and reduce the release of methane gas from landfill refuse.

The device reduces passage of gas, such as methane gas, therethrough. In some aspects, methane gas passage through the device is reduced by at least 5% as compared to a conventional or a reference device/synthetic turf that is otherwise identical to the inventive device but that does not include the polyurea or polyurethane coating disposed at a backing of the synthetic turf. In further aspects methane gas passage through the device is reduced by at least 10%, or at least 20%, or at least 30%, or at least 40%, or at least 50%, or at least 60%, or at least 70%, or at least 80%, or at least 90%, as compared to the conventional synthetic turf. Methane gas transmission/passage is determined according to conventional methods practiced by one skilled in the art.

In certain aspects, at least a portion of a surface of a synthetic turf may be treated with a polyurea-based or polyurethane-based coating. The treated surface of the synthetic turf may be the backing such as a woven fabric backing that situates the fibers or grasses together to create the turf.

The synthetic turf may be treated with a polyurea or polyurethane coating. For example, the synthetic turf may be treated with a coating of a polyurea or a polyurethane. A layer or a film comprising a polyurea or polyurethane coating may be disposed at a surface of the synthetic turf. For example, a film comprising a polyurea or polyurethane coating may be disposed at a surface of the synthetic turf may be disposed at a backing of the synthetic turf. In further examples, a film having a thickness of up to about 80 mil, or from about 10 mil to 100 mil, or from about 10 mil to about 70 mil, or from about 20 mil to about 70 mil, or from about 20 mil to about 80 mil, or from about 40 mil to about 80 mil, or from about 30 mil to 80 mil may be deposited at a surface of the synthetic turf.

The polyurea or polyurethane coating may be applied to the synthetic turf, for example at the backing, according to a number of suitable methods. In one example, the polyurea or polyurethane coating may be applied via spraying or a spraying mechanism. The method of applying the coating may be configured so as to substantially cover the surface (such as the backing) of the synthetic turf. Substantially may refer to greater than 50%, greater than 60%, greater than 70%, greater than 80%, greater than 85%, or greater than 90% of the surface or surface area of the synthetic turf at which the coating is applied.

As used herein, polyurethane may describe any polymer composed of chains of organic units linked by urethane (carbamate, —NH—COO—) bonds. Polyurethane polymers can be formed by reacting a molecule containing at least two isocyanate functional groups with another molecule containing at least two alcohol (hydroxyl) groups. By reacting an isocyanate group (—N═C═O) with a hydroxyl group (—OH), a urethane bond is formed. A catalyst may be used. Similarly, in polyurea, the bond is a urea group (—NH—CO—NH—) obtained by reacting an isocyanate group with an amine group —NH₂. For example, polyurethane can be produced by polyaddition reaction of polyisocyanate with a polyhydric alcohol (polyol, an example of which is macrodiol). The reaction mixture can also contain other additives.

As provided above, a polyurea or a polyurethane may be formed according to a number of methods in the art. In one example, polyurethane may be prepared through the reaction of a prepolymer component with a curative component. In an example, a prepolymer component and a curative component may be individually heated prior to mixing and before being applied as a coating at the synthetic turf. To provide a polyurethane, a prepolymer component, containing an isocyanate, and a curative may be reacted (heated and mixed) in the presence of a suitable polyurethane catalyst. Exemplary polyurethane catalysts may include metal containing compounds such as, but not limited to, dibutyltin dilaurate and bismuth octanoate, as well as other compositions comprising zinc or zirconium. Polyurethane catalysts may also include tertiary amines, such as, for example, 1,4-diazabicyclo[2.2.2]octane (DABCO) and N′N′-dimethylpiperazine. The amount of a given catalyst used can be an amount sufficient to reduce the occurrence of gelation and to reduce the cure time.

Aspects of the present disclosure relate at least to the following aspects.

Aspect 1. A device configured for trapping methane gas, the device comprising a synthetic turf; and a polyurea or polyurethane coating disposed at a backing of the synthetic turf, wherein the device reduces passage of methane gas therethrough.

Aspect 2. A coated synthetic turf comprising: a synthetic turf comprising a plurality of fibers and a backing; and a film, wherein the film comprises a polyurea, a polyurethane, or a combination thereof, wherein the coated synthetic turf is configured to reduce passage of methane gas.

Aspect 3. The coated synthetic turf of claim 2, wherein the film has a thickness of up to 80 mil.

Aspect 4. The coated synthetic turf of claim 2, wherein the film has a thickness of from 30 mil to 80 mil.

Aspect 5. The coated synthetic turf of claim 2, wherein the film is disposed adjacent the backing of the synthetic turf.

Aspect 6. The coated synthetic turf of claim 2, wherein at least a portion of the synthetic turf is configured as a covering for at least a portion of a landfill.

Aspect 7. A method comprising: applying a coating to at least a portion of a synthetic turf; placing the synthetic turf over a source of methane gas; and trapping at least a portion of methane gas below the synthetic turf.

Aspect 8. The method of claim 7, wherein the coating comprises a polyurea or polyurethane.

Aspect 9. The method of claim 7, wherein the coating is disposed adjacent at least a portion of a backing of a synthetic turf.

Ranges can be expressed herein as from one value (first value) to another value (second value). When such a range is expressed, the range includes in some aspects one or both of the first value and the second value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

It is to be understood that the present devices, components, and/or methods disclosed and described are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed. Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A device configured for trapping methane gas, the device comprising
a synthetic turf and
a polyurea or polyurethane coating disposed at a backing of the synthetic turf,
wherein the device reduces passage of methane gas therethrough.

2. A coated synthetic turf comprising:
a synthetic turf comprising a plurality of fibers and a backing; and
a film, wherein the film comprises a polyurea, a polyurethane, or a combination thereof,
wherein the coated synthetic turf is configured to reduce passage of methane gas.

3. The coated synthetic turf of claim 2, wherein the film has a thickness of up to 80 mil.

4. The coated synthetic turf of claim 2, wherein the film has a thickness of from 30 mil to 80 mil.

5. The coated synthetic turf of claim 2, wherein the film is disposed adjacent the backing of the synthetic turf.

6. The coated synthetic turf of claim 2, wherein at least a portion of the synthetic turf is configured as a covering for at least a portion of a landfill.

7. A method comprising:
applying a coating to at least a portion of a synthetic turf;
placing the synthetic turf over a source of methane gas; and
trapping at least a portion of methane gas below the synthetic turf.

8. The method of claim 7, wherein the coating comprises a polyurea or polyurethane.

9. The method of claim 7, wherein the coating is disposed adjacent at least a portion of a backing of a synthetic turf.
